(19) United States
(12) Patent Application Publication
(10) Pub. No.: US 2024/0113292 A1
(43) Pub. Date: Apr. 4, 2024

(54) BATTERY

(71) Applicant: Panasonic Intellectual Property Management Co., Ltd., Osaka (JP)

(72) Inventors: Yumi MIYAMOTO, Osaka (JP); Masahisa FUJIMOTO, Osaka (JP); Takashi OTO, Osaka (JP)

(21) Appl. No.: 18/527,140

(22) Filed: Dec. 1, 2023

Related U.S. Application Data
(63) Continuation of application No. PCT/JP2022/017746, filed on Apr. 13, 2022.

(30) Foreign Application Priority Data
Jun. 3, 2021 (JP) 2021-093942

(51) Int. Cl. H01M 4/505; H01M 4/131; H01M 4/134; H01M 4/38; H01M 4/66; H01M 10/052; H01M 10/0562

(52) U.S. Cl. CPC H01M 4/505; H01M 4/131; H01M 4/134; H01M 4/38; H01M 4/661; H01M 10/052; H01M 10/0562; H01M 2300/008; H01M 2300/0094

(57) ABSTRACT

A battery according to the present disclosure includes a positive electrode, a negative electrode, and an electrolyte layer positioned between the positive electrode and the negative electrode. The positive electrode includes a positive electrode material. The positive electrode material includes a positive electrode active material and a first solid electrolyte material. The positive electrode active material includes LiₓMn_{y}O₂, where 0≤x≤1.05 and 0.9≤y≤1.1 are satisfied. The negative electrode includes an alloy as a negative electrode active material, and the alloy includes Ni and Bi.

This application is a continuation of PCT/JP2022/017746 filed on Apr. 13, 2022, which claims foreign priority of Japanese Patent Application No. 2021-093942 filed on Jun. 3, 2021, the entire contents of both of which are incorporated herein by reference.

### BACKGROUND OF THE INVENTION

### 1. Field of the Invention

The present disclosure relates to a battery.

### 2. Description of Related Art

JP H3-43968 A discloses that a product obtained by mixing and firing LiOH and MnO₂ is used as a positive electrode active material. In the examples of JP H3-43968 A, batteries are disclosed in which the positive electrode active material and a LiPb alloy as a negative electrode active material are used.

“Lithium Containing Manganese Dioxide (Composite Dimensional Manganese Oxide-CDMO) as a Cathode Active Material for Lithium Secondary Batteries)”, Nobuhiro FURUKAWA, Toshiyuki NOHMA, Kazuo TERAJI, Ikuro NAKANE, Yuji YAMAMOTO, and Toshihiko SAITO, Electrochemistry, Vol. 57, No. 6, pp. 533-538 (1989) demonstrates that a product obtained by mixing and firing LiOH and MnO₂ is a composite of Li₂MnO₃ and MnO₂.

WO 2019/146216 A1 discloses an all-solid-state battery including a halide solid electrolyte.

### SUMMARY OF THE INVENTION

The present disclosure provides a novel and operable battery including LiₓMn_{y}O₂ (0≤x≤1.05 and 0.9≤y≤1.1) as a positive electrode active material and including an alloy including Ni and Bi as a negative electrode active material.

A battery of the present disclosure includes:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes a material represented by the following composition formula (1)

LiₓMn_{y}O₂ Formula (1),
the composition formula (1) satisfies 0≤x≤1.05 and 0.9≤y≤1.1, and
the negative electrode includes an alloy as a negative electrode active material, the alloy including Ni and Bi.

The present disclosure provides a novel and operable battery including LiₓMn_{y}O₂ (0≤x≤1.05 and 0.9≤y≤1.1) as a positive electrode active material and including an alloy including Ni and Bi as a negative electrode active material.

### BRIEF DESCRIPTION OF THE DRAWINGS

FIG. 1 is a cross-sectional view schematically showing the configuration of a battery 2000 of Embodiment 1.

FIG. 2 is a cross-sectional view schematically showing the configuration of a battery 3000 of Embodiment 2.

FIG. 3 is a graph showing the X-ray diffraction pattern of NiBi produced on a nickel foil in Example 1.

FIG. 4 is a graph showing the charge and discharge curves of a battery of Example 1.

### DETAILED DESCRIPTION

### Outline of One Aspect According to the Present Disclosure

A battery according to a first aspect of the present disclosure includes:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes a material represented by the following composition formula (1)

LiₓMn_{y}O₂ Formula (1),
the composition formula (1) satisfies 0≤x≤1.05 and 0.9≤y≤1.1, and
the negative electrode includes an alloy as a negative electrode active material, the alloy including Ni and Bi.

The first aspect provides a novel and operable battery including LiₓMn_{y}O₂ (0≤x≤1.05 and 0.9≤y≤1.1) as a positive electrode active material and including an alloy including Ni and Bi as a negative electrode active material.

In a second aspect of the present disclosure, for example, in the battery according to the first aspect, the composition formula (1) may satisfy 0≤x≤1.

In the battery according to the second aspect, the positive electrode active material sufficiently occludes and releases Li.

In a third aspect of the present disclosure, for example, in the battery according to the second aspect, the composition formula (1) may satisfy x=1.

In the battery according to the third aspect, the positive electrode active material more sufficiently occludes and releases Li, and consequently charge and discharge at a large depth can be achieved.

In a fourth aspect of the present disclosure, for example, in the battery according to any one of the first to third aspects, the composition formula (1) may satisfy y=1.

In the battery according to the fourth aspect, the positive electrode active material more sufficiently occludes and releases Li, and consequently charge and discharge at a large depth can be achieved.

In a fifth aspect of the present disclosure, for example, in the battery according to any one of the first to fourth aspects, the negative electrode may include, as a main component of the negative electrode active material, the alloy including Ni and Bi.

The fifth aspect enhances the flatness of the discharge voltage of the negative electrode, thereby operating the battery more favorably.

In a sixth aspect of the present disclosure, for example, in the battery according to any one of the first to fifth aspects, the alloy including Ni and Bi may be represented by the following composition formula (2)

NiBiₐ Formula (2), and
the composition formula (2) satisfies 0<a≤3.

The sixth aspect enhances the flatness of the discharge voltage of the negative electrode.

In a seventh aspect of the present disclosure, for example, in the battery according to the sixth aspect, the composition formula (2) may satisfy a=1.

The battery according to the seventh aspect operates more favorably.

In an eighth aspect of the present disclosure, for example, in the battery according to any one of the first to seventh aspects, the negative electrode may include a material represented by the following composition formula (3)

Li_{z}Bi Formula (3), and
the composition formula (3) satisfies 0<z≤3.

In the battery according to the eighth aspect, Li is sufficiently occluded and released in the negative electrode.

In a ninth aspect of the present disclosure, for example, in the battery according to the eighth aspect, the composition formula (1) may satisfy x=0 and y=1, and the composition formula (3) may satisfy z=3.

In the battery according to the ninth aspect, Li is sufficiently occluded and released in the positive electrode and the negative electrode.

In a tenth aspect of the present disclosure, for example, the battery according to any one of the first to ninth aspects may further include a negative electrode current collector electrically connected to the negative electrode, wherein the negative electrode current collector may include Ni.

In the battery according to the tenth aspect, electricity can be collected stably.

In an eleventh aspect of the present disclosure, for example, in the battery according to any one of the first to tenth aspects, the negative electrode may be a plating layer.

The battery according to the eleventh aspect has an enhanced capacity.

In a twelfth aspect of the present disclosure, for example, in the battery according to any one of the first to eleventh aspects, the first solid electrolyte material may include: Li; at least one selected from the group consisting of metalloid elements and metal elements except Li; and at least one selected from the group consisting of Cl and Br.

The battery according to the twelfth aspect has an enhanced capacity.

In a thirteenth aspect of the present disclosure, for example, in the battery according to the twelfth aspect, the first solid electrolyte material may include a material represented by the following composition formula (4)

Li_{α4}M_{β4}X_{γ4} Formula (4)
where α4, β4, and γ4 are each a value greater than 0,
M is at least one selected from the group consisting of metalloid elements and metal elements except Li, and
X is at least one selected from the group consisting of Cl and Br.

In the battery according to the thirteenth aspect, the ionic conductivity of the first solid electrolyte material can be enhanced. Consequently, resistance derived from migration of Li ions can be reduced, thereby suppressing an increase in the internal resistance of the battery during charge.

In a fourteenth aspect of the present disclosure, for example, in the battery according to the thirteenth aspect, the composition formula (4) may satisfy:

2.5≤α4≤3;

1≤β4≤1.1; and

γ4=6.

In the battery according to the fourteenth aspect, the ionic conductivity of the first solid electrolyte material can be further enhanced. Consequently, resistance derived from migration of Li ions can be further reduced, thereby more effectively suppressing an increase in the internal resistance of the battery during charge.

In a fifteenth aspect of the present disclosure, for example, in the battery according to any one of the first to fourteenth aspects, the electrolyte layer may include a first electrolyte layer and a second electrolyte layer, the first electrolyte layer may be positioned between the positive electrode and the negative electrode, and the second electrolyte layer may be positioned between the first electrolyte layer and the negative electrode.

In the battery according to the fifteenth aspect, an increase in internal resistance during charge can be suppressed.

Embodiments of the present disclosure will be described below with reference to the drawings. The following descriptions are each a generic or specific example. The following numerical values, composition, shape, film thickness, electrical characteristics, battery structure, and the like are only exemplary, and are not intended to limit the present disclosure.

### Embodiment 1

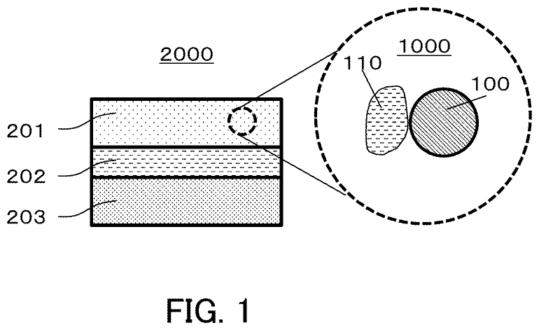

FIG. 1 is a cross-sectional view schematically showing the configuration of a battery 2000 of Embodiment 1 of the present disclosure.

The battery 2000 includes a positive electrode 201, a negative electrode 203, and an electrolyte layer 202 positioned between the positive electrode 201 and the negative electrode 203. The positive electrode 201 includes a positive electrode material 1000. The positive electrode material 1000 includes a positive electrode active material 110 and a first solid electrolyte material 100. The positive electrode active material 110 includes a material represented by the following composition formula (1).

LiₓMn_{y}O₂ Formula (1)

The composition formula (1) satisfies 0≤x≤1.05 and 0.9≤y≤1.1.

The negative electrode 203 includes an alloy as the negative electrode active material, and the alloy includes Ni and Bi.

The constitutional elements of the battery 2000 of the present embodiment will be described below.

### [Positive Electrode 201]

As described above, the positive electrode 201 includes the positive electrode material 1000. The positive electrode material 1000 includes the positive electrode active material 110 and the first solid electrolyte material 100. The positive electrode active material 110 includes a material represented by the following composition formula (1).

LiₓMn_{y}O₂ Formula (1)

The composition formula (1) satisfies 0≤x≤1.05 and 0.9≤y≤1.1.

The composition formula (1) may satisfy 0≤x≤1.

The composition formula (1) may satisfy x=1.

The composition formula (1) may satisfy y=1. That is, the positive electrode active material 110 may include LiMnO₂.

A material represented by the composition formula (1) is free of Co, and is inexpensive accordingly. With the above configuration, the cost of the battery 2000 can be reduced.

The positive electrode active material 110 may consist of a material represented by the composition formula (1). The positive electrode active material 110 may consist of LiMnO₂.

The first solid electrolyte material 100 may include: Li; at least one selected from the group consisting of metalloid elements and metal elements except Li; and at least one selected from the group consisting of Cl and Br.

The “metalloid elements” refer to B, Si, Ge, As, Sb, and Te.

The “metal elements” refer to all the elements included in Groups 1 to 12 of the periodic table except hydrogen and all the elements included in Groups 13 to 16 except B, Si, Ge, As, Sb, Te, C, N, P, O, S, and Se. That is, the “metal elements” are a group of elements that can become a cation when forming an inorganic compound with a halogen compound.

With the above configuration, the positive electrode material 1000 has a high oxidation resistance. Consequently, an increase in the internal resistance of the battery 2000 during charge can be suppressed.

The first solid electrolyte material 100 may include a material represented by the following composition formula (4).

Li_{α4}M_{β4}X_{γ4} Formula (4)

In the composition formula (4), α4, β4, and γ4 are each a value greater than 0, M is at least one selected from the group consisting of metalloid elements and metal elements except Li, and X is at least one selected from the group consisting of Cl and Br.

With the above configuration, the ionic conductivity of the first solid electrolyte material 100 can be further enhanced. Consequently, resistance derived from migration of Li ions in the positive electrode material 1000 of the battery can be further reduced.

In the composition formula (4), M may include Y. That is, the first solid electrolyte material 100 may include Y as a metal element.

With the above configuration, the ionic conductivity of the first solid electrolyte material 100 can be further enhanced. Consequently, resistance derived from migration of Li ions in the positive electrode material 1000 of the battery can be further reduced.

The composition formula (4) may satisfy 1≤α4≤4, 0<β4≤2, and 3≤γ4<7.

The composition formula (4) may satisfy 2.5≤α4≤3, 1≤β4≤1.1, and γ4=6.

With the above configuration, the ionic conductivity of the first solid electrolyte material 100 can be further enhanced. Consequently, resistance derived from migration of Li ions in the positive electrode material 1000 can be further reduced.

The first solid electrolyte material 100 including Y may be, for example, a compound represented by a composition formula LiₐMe_{b}Y_{c}X₆. Here, a+m′b+3c=6 and c>0 are satisfied. Me is at least one element selected from the group consisting of metalloid elements and metal elements except Li and Y. Furthermore, m′ represents the valence of Me.

Me may be at least one element selected from the group consisting of Mg, Ca, Sr, Ba, Zn, Sc, Al, Ga, Bi, Zr, Hf, Ti, Sn, Ta, and Nb.

With the above configuration, the ionic conductivity of the first solid electrolyte material 100 can be further enhanced. Consequently, resistance derived from migration of Li ions in the positive electrode material 1000 of the battery can be further reduced.

The first solid electrolyte material 100 may be a material represented by the following composition formula (A1).

Li_{6-3d}Y_{d}X₆ Formula (A1)

In the composition formula (A1), X is a halogen element and includes Cl. Furthermore, the composition formula (A1) satisfies 0<d<2.

With the above configuration, the ionic conductivity of the first solid electrolyte material 100 can be further enhanced. Consequently, resistance derived from migration of Li ions in the positive electrode material 1000 can be further reduced.

The first solid electrolyte material 100 may be a material represented by the following composition formula (A2).

Li₃YX₆ Formula (A2)

In the composition formula (A2), X is a halogen element and includes Cl.

With the above configuration, the ionic conductivity of the first solid electrolyte material 100 can be further enhanced. Consequently, resistance derived from migration of Li ions in the positive electrode material 1000 of the battery can be further reduced.

The first solid electrolyte material 100 may include Li₃YBr₂Cl₄. The first solid electrolyte material 100 may be Li₃YBr₂Cl₄.

The first solid electrolyte material 100 may be a material represented by the following composition formula (A3).

Li_{3-3δ}Y_{1+δ}Cl₆ Formula (A3)

The composition formula (A3) satisfies 0<δ≤0.15.

With the above configuration, the ionic conductivity of the first solid electrolyte material 100 can be further enhanced. Consequently, resistance derived from migration of Li ions in the positive electrode material 1000 of the battery can be further reduced.

The first solid electrolyte material 100 may be a material represented by the following composition formula (A4).

Li_{3-3δ+a4}Y_{1+δ-a4}Meₐ₄Cl₆₋ₓ₄Brₓ₄ Formula (A4)

In the composition formula (A4), Me is at least one element selected from the group consisting of Mg, Ca, Sr, Ba, and Zn. Furthermore, the composition formula (A4) satisfies −1<δ<2, 0<a4<3, 0<(3−3δ+a4), 0<(1+δ−a4), and 0≤x4<6.

With the above configuration, the ionic conductivity of the first solid electrolyte material 100 can be further enhanced. Consequently, resistance derived from migration of Li ions in the positive electrode material 1000 of the battery can be further reduced.

The first solid electrolyte material 100 may be a material represented by the following composition formula (A5).

Li_{3-3δ}Y_{1+δ-a5}Meₐ₅Cl₆₋ₓ₅Brₓ₅ Formula (A5)

In the composition formula (A5), Me is at least one element selected from the group consisting of A1, Sc, Ga, and Bi. Furthermore, the composition formula (A5) satisfies −1<δ<1, 0<a5<2, 0<(1+δ−a5), and 0≤x5<6.

With the above configuration, the ionic conductivity of the first solid electrolyte material 100 can be further enhanced. Consequently, resistance derived from migration of Li ions in the positive electrode material 1000 can be further reduced.

The first solid electrolyte material 100 may be a material represented by the following composition formula (A6).

Li_{3-3δ-a6}Y_{1+δ-a6}Meₐ₆Cl₆₋ₓ₆Brₓ₆ Formula (A6)

In the composition formula (A6), Me is at least one element selected from the group consisting of Zr, Hf, and Ti. Furthermore, the composition formula (A6) satisfies −1<δ<1, 0<a6<1.5, 0<(3−3δ−a6), 0<(1+δ−a6), and 0≤x6<6.

The first solid electrolyte material 100 may be a material represented by the following composition formula (A7).

Li_{3-3δ-2a7}Y_{1+δ-a7}Meₐ₇Cl₆₋ₓ₇Brₓ₇ Formula (A7)

In the composition formula (A7), Me is at least one element selected from the group consisting of Ta and Nb. Furthermore, the composition formula (A7) satisfies −1<δ <1, 0<a7<1.2, 0<(3−3δ−2a7), 0<(1+δ−a7), and 0≤x7<6.

The first solid electrolyte material 100 can be, for example, Li₃YX₆, Li₂MgX₄, Li₂FeX₄, Li(Al,Ga,In)X₄, or Li₃(Al,Ga,In)X₆. Here, X includes Cl. Note that, in the present disclosure, when an element in a formula is expressed by, for example, “(Al,Ga,In)”, this expression indicates at least one element selected from the group of elements in parentheses. That is, “(Al,Ga,In)” is synonymous with “at least one selected from the group consisting of Al, Ga, and In”. The same applies to other elements. In addition, the first solid electrolyte material 100 may be free of sulfur.

The first solid electrolyte material 100 may include a sulfide solid electrolyte. The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Furthermore, LiX, Li₂O, MO_{q}, LiₚMO_{q}, or the like may be added to these. Here, X is at least one element selected from the group consisting of F, Cl, Br, and I. M is at least one element selected from the group consisting of P, Si, Ge, B, Al, Ga, In, Fe, and Zn. The symbols p and q are each independently a natural number.

The first solid electrolyte material 100 may include lithium sulfide and phosphorus sulfide. The sulfide solid electrolyte may be at least one selected from the group consisting of Li₂S—P₂S₅ and Li₆PS₅Cl.

The shape of the first solid electrolyte material 100 is not particularly limited. In the case where the first solid electrolyte material 100 is a powdery material, its shape may be, for example, an acicular, spherical, or ellipsoidal shape. The first solid electrolyte material 100 may be, for example, particulate.

For example, in the case where the first solid electrolyte material 100 is particulate (e.g., spherical), the first solid electrolyte material 100 may have a median diameter of 100 μm or less. In the case where the first solid electrolyte material 100 has a median diameter of 100 μm or less, the positive electrode active material 110 and the first solid electrolyte material 100 can form a favorable dispersion state in the positive electrode material 1000. This enhances the charge and discharge characteristics of the battery 2000.

The first solid electrolyte material 100 may have a median diameter of 10 μm or less. With the above configuration, the positive electrode active material 110 and the first solid electrolyte material 100 can form a favorable dispersion state in the positive electrode material 1000.

In Embodiment 1, the first solid electrolyte material 100 may have a smaller median diameter than the positive electrode active material 110 has. With the above configuration, the first solid electrolyte material 100 and the positive electrode active material 110 can form a more favorable dispersion state in the positive electrode.

The positive electrode active material 110 may have a median diameter of 0.1 μm or more and 100 μm or less.

In the case where the positive electrode active material 110 has a median diameter of 0.1 μm or more, the positive electrode active material 110 and the first solid electrolyte material 100 can form a favorable dispersion state in the positive electrode material 1000. This enhances the charge and discharge characteristics of the battery including the positive electrode material 1000. In the case where the positive electrode active material 110 has a median diameter of 100 μm or less, the diffusion rate of lithium in the positive electrode active material 110 is enhanced. Consequently, the battery 2000 can operate at a high power.

The positive electrode active material 110 may have a larger median diameter than the first solid electrolyte material 100 has. In this case, the positive electrode active material 110 and the first solid electrolyte material 100 can form a favorable dispersion state.

In the present disclosure, the “median diameter” means the particle diameter at a cumulative volume equal to 50% in the volumetric particle size distribution. The volumetric particle size distribution is measured, for example, with a laser diffraction analyzer or an image analyzer.

The positive electrode material 1000 may further include a positive electrode active material other than the positive electrode active material 110.

Positive electrode active materials include a material having properties of occluding and releasing metal ions (e.g., lithium ions). The positive electrode active material other than the positive electrode active material 110 can be, for example, a lithium-containing transition metal oxide, a transition metal fluoride, a polyanion material, a fluorinated polyanion material, a transition metal sulfide, a transition metal oxysulfide, or a transition metal oxynitride. Examples of the lithium-containing transition metal oxide include Li(Ni,Co,Al)O₂, Li(Ni,Co,Mn)O₂, and LiCoO₂. In particular, in the case where the lithium-containing transition metal oxide is used, it is possible to reduce the manufacturing cost of the positive electrode material 1000, and to enhance the average discharge voltage.

The positive electrode material 1000 included in the battery 2000 of Embodiment 1 may include the plurality of first solid electrolyte materials 100 and the plurality of positive electrode active materials 110.

In the positive electrode material 1000, the content of the first solid electrolyte material 100 and the content of the positive electrode active material 110 may be the same or different from each other.

In the positive electrode material 1000, the first solid electrolyte material 100 and the positive electrode active material 110 may be in contact with each other as shown in FIG. 1.

In the volume ratio “v1:100-v1” between the positive electrode active material 110 and the first solid electrolyte material 100 included in the positive electrode 201, 30≤v1≤98 may be satisfied. Here, v1 represents the volume ratio of the positive electrode active material 110 based on 100 of the total volume of the positive electrode active material 110 and the first solid electrolyte material 100 included in the positive electrode 201. In the case where 30≤v1 is satisfied, a sufficient energy density of the battery can be ensured. In the case where v1≤98 is satisfied, the battery 2000 can operate at a high power.

At least a portion of the surface of the positive electrode active material 110 may be coated with a coating material.

Examples of the coating material include a sulfide solid electrolyte, an oxide solid electrolyte, and a halide solid electrolyte. The sulfide solid electrolyte used as the coating material may be the same material as any of the materials exemplified for the first solid electrolyte material 100. Examples of the oxide solid electrolyte used as the coating material include a Li—Nb—O compound, such as LiNbO₃, a Li—B—O compound, such as LiBO₂ or Li₃BO₃, a Li-A1-O compound, such as LiAlO₂, a Li—Si—O compound, such as Li₄SiO₄, a Li—Ti—O compound, such as Li₂SO₄ or Li₄Ti₅O₁₂, a Li—Zr—O compound, such as Li₂ZrO₃, a Li—Mo—O compound, such as Li₂MoO₃, a Li-V-O compound, such as LiV₂O₅, a Li—W—O compound, such as Li₂WO₄, and a Li—P—O compound, such as Li₃PO₄. The halide solid electrolyte may be free of sulfur.

The positive electrode 201 may have a thickness of 10 μm or more and 500 μm or less. In the case where the positive electrode 201 has a thickness of 10 μm or more, a sufficient energy density of the battery can be ensured. In the case where the positive electrode 201 has a thickness of 500 μm or less, the battery 2000 can operate at a high power.

### [Electrolyte Layer 202]

The electrolyte layer 202 is disposed between the positive electrode 201 and the negative electrode 203.

The electrolyte layer 202 includes an electrolyte material. The electrolyte material is, for example, a solid electrolyte material. The electrolyte layer 202 may be a solid electrolyte layer.

The solid electrolyte material included in the electrolyte layer 202 may be the same material as the first solid electrolyte material 100. That is, the electrolyte layer 202 may include the same material as the first solid electrolyte material 100.

The solid electrolyte material included in the electrolyte layer 202 may be a halide solid electrolyte, a sulfide solid electrolyte, an oxide solid electrolyte, a polymer solid electrolyte, or a complex hydride solid electrolyte.

The oxide solid electrolyte, which may be included in the electrolyte layer 202, can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or glass or glass ceramics including a Li—B—O compound, such as LiBO₂ or Li₃BO₃, as a base, and to which Li₂SO₄, Li₂CO₃, or the like is added.

The polymer solid electrolyte, which may be included in the electrolyte layer 202, can be, for example, a compound of a polymer compound and a lithium salt. The polymer compound may have an ethylene oxide structure. The polymer compound having an ethylene oxide structure can include a large amount of a lithium salt. Consequently, the ionic conductivity can be further enhanced. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. One lithium salt selected from the exemplified lithium salts can be used alone.

Alternatively, a mixture of two or more lithium salts selected from the exemplified lithium salts can be used.

The complex hydride solid electrolyte, which may be included in the electrolyte layer 202, can be, for example, LiBH₄—LiI or LiBH₄—P₂S₅.

The electrolyte layer 202 may include the solid electrolyte material as its main component. That is, the electrolyte layer 202 may include the solid electrolyte material, for example, in a mass proportion of 50% or more (i.e., 50 mass % or more) to the entire electrolyte layer 202.

With the above configuration, the charge and discharge characteristics of the battery 2000 can be enhanced.

The electrolyte layer 202 may include the solid electrolyte material, for example, in a mass proportion of 70% or more (i.e., 70 mass % or more) to the entire electrolyte layer 202.

With the above configuration, the charge and discharge characteristics of the battery 2000 can be further enhanced.

The electrolyte layer 202 may include the solid electrolyte material as its main component and further include inevitable impurities, a starting material used for synthesis of the solid electrolyte material, a by-product, a decomposition product, etc.

The electrolyte layer 202 may include the solid electrolyte material, for example, in a mass proportion of 100% (i.e., 100 mass %) to the entire electrolyte layer 202, except for inevitably incorporated impurities.

With the above configuration, the charge and discharge characteristics of the battery 2000 can be further enhanced.

Thus, the electrolyte layer 202 may consist of the solid electrolyte material.

The electrolyte layer 202 may include two or more of the materials listed as the solid electrolyte material. For example, the electrolyte layer 202 may include a halide solid electrolyte and a sulfide solid electrolyte.

The electrolyte layer 202 may have a thickness of 1 μm or more and 300 μm or less. In the case where the electrolyte layer 202 has a thickness of 1 μm or more, a short circuit between the positive electrode 201 and the negative electrode 203 tends not to occur. In the case where the electrolyte layer 202 has a thickness of 300 μm or less, the battery 2000 can operate at a high power.

The description has been provided here mainly on the case where the electrolyte layer 202 is a solid electrolyte layer including a solid electrolyte material. Alternatively, the electrolyte material included in the electrolyte layer 202 may be an electrolyte solution. For example, the electrolyte layer 202 may be composed of a separator and an electrolyte solution with which the separator is impregnated.

### [Negative Electrode 203]

The negative electrode 203 includes a material having properties of occluding and releasing metal ions (e.g., lithium ions). That is, the negative electrode 203 includes the negative electrode active material. The negative electrode 203 includes, as the negative electrode active material, the alloy including Ni and Bi.

Bi is a metal element that alloys with lithium. In contrast, Ni tends not to alloy with lithium. Accordingly, an alloy including Ni is inferred to have a reduced load on the crystal structure of the negative electrode active material in intercalation and deintercalation of lithium atoms during charge and discharge, and thus suppress a decrease in the capacity retention rate of the battery. For example, in the case where the negative electrode active material is NiBi, lithium is occluded into Bi and thus Bi forms an alloy with lithium during charge. That is, during charge of the battery 2000, a lithium-bismuth alloy is generated in the negative electrode 203. The lithium-bismuth alloy generated includes, for example, at least one selected from the group consisting of LiBi and Li₃Bi. That is, during charge of the battery 2000, the negative electrode 203 includes, for example, at least one selected from the group consisting of LiBi and Li₃Bi. During discharge of the battery 2000, lithium is released from the lithium-bismuth alloy and thus the lithium-bismuth alloy returns to NiBi.

The negative electrode 203 may include, as the main component of the negative electrode active material, the alloy including Ni and Bi.

The phrase “the negative electrode 203 includes, as the main component of the negative electrode active material, the alloy including Ni and Bi” means that “the component having the highest content as the negative electrode active material on a molar ratio basis in the negative electrode 203 is the alloy including Ni and Bi”.

The negative electrode 203 may include, as the negative electrode active material, only the alloy including Ni and Bi.

The alloy including Ni and Bi may be represented by the following composition formula (2).

NiBiₐ Formula (2)

The composition formula (2) satisfies 0<a≤3.

The composition formula (2) may satisfy a=1. That is, the negative electrode 203 may include NiBi as the negative electrode active material. The negative electrode 203 may include NiBi as the main component of the negative electrode active material. The negative electrode 203 may include only NiBi as the negative electrode active material.

The negative electrode 203 may include a material represented by the following composition formula (3).

Li_{z}Bi Formula (3)

The composition formula (3) satisfies 0<z≤3.

In the case where the composition formula (1) satisfies x=0 and y=1, the composition formula (3) may satisfy z=3. That is, in the case where the positive electrode active material 110 includes MnO₂, the negative electrode 203 may include Li₃Bi.

The composition formula (3) may satisfy z=1 or z=3. The negative electrode 203 may include at least one selected from the group consisting of LiBi and Li₃Bi.

The negative electrode 203 may include, as the negative electrode active material, a material other than the alloy including Ni and Bi.

The negative electrode active material can be a metal material, a carbon material, an oxide, a nitride, a tin compound, a silicon compound, or the like. The metal material may be a simple substance of metal. Alternatively, the metal material may be an alloy.

Examples of the metal material include lithium metal and a lithium alloy. Examples of the carbon material include natural graphite, coke, semi-graphitized carbon, a carbon fiber, spherical carbon, artificial graphite, and amorphous carbon. From the viewpoint of capacity density, silicon, tin, a silicon compound, or a tin compound can be used.

The negative electrode 203 may be free of an electrolyte. The negative electrode 203 may be, for example, a layer formed of a material represented by the composition formula (2).

The negative electrode 203 may be filmy.

The negative electrode 203 may be a plating layer.

The negative electrode 203 may be a plating layer formed by depositing the alloy including Ni and Bi by plating.

The thickness of the negative electrode 203 is not particularly limited, and may be, for example, 1 μm or more and 500 μm or less. For example, in the case where the negative electrode 203 is a plating layer formed of the alloy including Ni and Bi, the negative electrode 203 may have a thickness of, for example, 1 μm or more and 100 μm or less. In the case where the negative electrode 203 has a thickness of 1 μm or more, a sufficient energy density of the battery 2000 can be ensured. In the case where the negative electrode 203 has a thickness of 500 μm or less, the battery 2000 can operate at a high power.

The negative electrode 203 may further include a conductive material. Examples of the conductive material include a carbon material, a metal, an inorganic compound, and a conductive polymer. Examples of the carbon material include graphite, acetylene black, carbon black, Ketjenblack, a carbon whisker, needle coke, and a carbon fiber. Examples of the graphite include natural graphite and artificial graphite. Examples of the natural graphite include vein graphite and flake graphite. Examples of the metal include copper, nickel, aluminum, silver, and gold. Examples of the inorganic compound include tungsten carbide, titanium carbide, tantalum carbide, molybdenum carbide, titanium boride, and titanium nitride. These materials may be used alone or in mixture.

In the battery 2000 of Embodiment 1, a current collector electrically connected to the positive electrode 201 and a current collector electrically connected to the negative electrode 203 may be provided. That is, the battery 2000 may further include a positive electrode current collector and a negative electrode current collector.

The negative electrode 203 may be disposed in direct contact with the surface of the negative electrode current collector.

The negative electrode 203 may be a plating layer formed by depositing the alloy including Ni and Bi on the negative electrode current collector by plating. The negative electrode 203 may be a plating layer formed of the alloy including Ni and Bi provided in direct contact with the surface of the negative electrode current collector.

In the case where the negative electrode 203 is a plating layer provided in direct contact with the surface of the negative electrode current collector, the negative electrode 203 is in close contact with the negative electrode current collector. Consequently, it is possible to suppress a deterioration in the current collection characteristics of the negative electrode 203 caused by repetition of expansion and contraction of the negative electrode 203. This further enhances the charge and discharge characteristics of the battery 2000.

Furthermore, in the case where the negative electrode 203 is a plating layer formed of the alloy including Ni and Bi, the negative electrode 203 includes a high density of the alloy including Ni and Bi, which are active materials. Consequently, a further increase in capacity can also be achieved.

The material for the negative electrode current collector is, for example, a simple substance of metal or an alloy. More specifically, the material may be a simple substance of metal including, or an alloy including, at least one selected from the group consisting of copper, chromium, nickel, titanium, platinum, gold, aluminum, tungsten, iron, and molybdenum. The material for the negative electrode current collector may be stainless steel. In addition, these materials can also be used as the material for the positive electrode current collector.

The negative electrode current collector may include nickel (Ni).

To easily ensure a high conductivity, the negative electrode current collector may be a metal foil, and may be a metal foil including Ni. Examples of the metal foil including Ni include a Ni foil and a Ni alloy foil. The content of Ni in the metal foil including Ni may be 50 mass % or more or 80 mass % or more. In particular, the metal foil including Ni may be a Ni foil including substantially only Ni as a metal.

The negative electrode 203 may be NiBi synthesized by electroplating the surface of the negative electrode current collector including Ni with Bi.

At least one selected from the group consisting of the positive electrode 201, the electrolyte layer 202 and the negative electrode 203 may include a binder for the purpose of enhancing the adhesion between the particles. The binder is used to enhance the binding properties of the materials for the electrodes. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, the binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Moreover, a mixture of two or more selected from these may be used.

At least one selected from the group consisting of the positive electrode 201 and the negative electrode 203 may include a conductive additive for the purpose of enhancing the electronic conductivity. The conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline compound, polypyrrole compound, or polythiophene compound. In the case where a conductive carbon additive is used as the conductive additive, cost reduction can be achieved.

The shape of the battery 2000 of Embodiment 1 is, for example, a coin type, a cylindrical type, a prismatic type, a sheet type, a button type, a flat type, or a stack type.

The battery 2000 of Embodiment 1 may be manufactured, for example, by preparing each of a material for forming a positive electrode, a material for forming an electrolyte layer, and a material for forming a negative electrode, and producing by a known method a stack in which the positive electrode, the electrolyte layer, and the negative electrode are disposed in this order.

### Embodiment 2

Embodiment 2 will be described below. The description overlapping with that of Embodiment 1 will be omitted as appropriate.

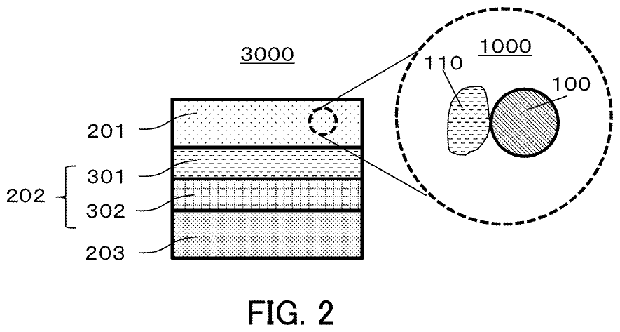

FIG. 2 is a cross-sectional view schematically showing the configuration of a battery 3000 of Embodiment 2.

The battery 3000 of Embodiment 2 includes the positive electrode 201, the electrolyte layer 202, and the negative electrode 203. The electrolyte layer 202 is disposed between the positive electrode 201 and the negative electrode 203. The electrolyte layer 202 includes a first electrolyte layer 301 and a second electrolyte layer 302. The first electrolyte layer 301 is positioned between the positive electrode 201 and the negative electrode 203, and the second electrolyte layer 302 is positioned between the first electrolyte layer 301 and the negative electrode 203. In FIG. 2, a configuration example of the battery 3000 is shown in which the first electrolyte layer 301 is in contact with the positive electrode 201 and the second electrolyte layer 302 is in contact with the negative electrode 203.

With the above configuration, an increase in the internal resistance of the battery 3000 during charge can be suppressed.

The first electrolyte layer 301 and the second electrolyte layer 302 may be solid electrolyte layers.

From the viewpoint of the reduction resistance of solid electrolyte materials, the reduction potential of the solid electrolyte material included in the second electrolyte layer 302 may be lower than the reduction potential of the solid electrolyte material included in the first electrolyte layer 301. With the above configuration, the solid electrolyte material included in the first electrolyte layer 301 can be used without being reduced. Consequently, the charge and discharge efficiency of the battery 3000 can be enhanced.

For example, the second electrolyte layer 302 may include a sulfide solid electrolyte. In this case, the reduction potential of the sulfide solid electrolyte included in the second electrolyte layer 302 is lower than the reduction potential of the solid electrolyte material included in the first electrolyte layer 301. With the above configuration, the solid electrolyte material included in the first electrolyte layer 301 can be used without being reduced. Consequently, the charge and discharge efficiency of the battery 3000 can be enhanced.

The first electrolyte layer 301 and the second electrolyte layer 302 each may have a thickness of 1 μm or more and 300 μm or less. In the case where the first electrolyte layer 301 and the second electrolyte layer 302 each have a thickness of 1 μm or more, a short circuit between the positive electrode 201 and the negative electrode 203 tends not to occur. In the case where the first electrolyte layer 301 and the second electrolyte layer 302 each have a thickness of 300 μm or less, the battery 3000 can operate at a high power.

### EXAMPLE

The present disclosure will be described below in more detail with reference to an example.

### Example 1

### [Production of First Solid Electrolyte Material]

In an argon atmosphere, raw material powders LiBr, YBr₃, LiCl, and YCl₃ were weighed in a molar ratio of LiBr:YBr₃:LiCl:YCl₃=1:1:5:1. Subsequently, these raw material powders were milled with a planetary ball mill (Type P-7 manufactured by Fritsch GmbH) at 600 rpm for 25 hours thus to obtain powdered Li₃YBr₂Cl₄ as the first solid electrolyte material.

### [Production of Positive Electrode Active Material]

Benzophenone and methyl ethyl carbonate were mixed together to prepare a mixed solution. The concentration of benzophenone in the mixed solution was 1 mol/L. Li metal was dissolved in the mixed solution until the saturated concentration was reached. Thus, a lithium solution was prepared. The concentration of lithium in the lithium solution was 1 mol/L. In the lithium solution prepared, γ-β-MnO₂ was immersed for 1.8 days. Subsequently, the lithium solution was removed, followed by cleaning with methyl ethyl carbonate and vacuum drying. Thus, a positive electrode active material LiₓMn_{y}O₂ (0<x≤1.05 and 0.9≤y≤1.1) was obtained.

### [Production of Positive Electrode Material]

The positive electrode active material produced, the first solid electrolyte material produced, and vapor-grown carbon fibers (VGCF (manufactured by SHOWA DENKO K.K.)) as the conductive additive were weighed in a mass ratio of the positive electrode active material:the first solid electrolyte material:VGCF=27.75:64.75:7.5, and were mixed together in a mortar. Thus, a positive electrode material of Example 1 was produced. Note that VGCF is the registered trademark of SHOWA DENKO K.K.

### [Production of Negative Electrode]

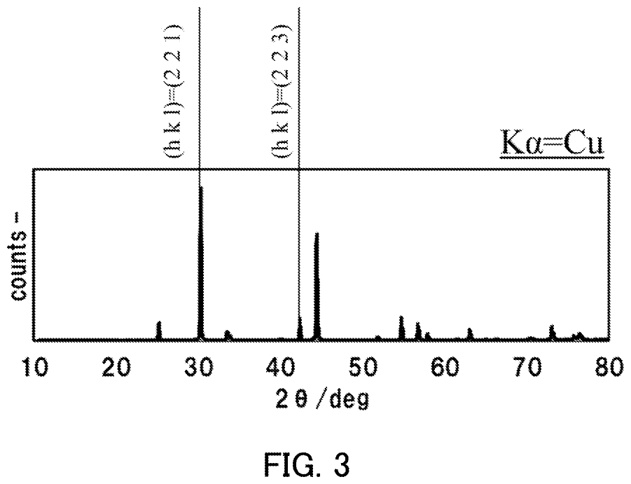

A pretreatment was performed in which a nickel foil (10 cm×10 cm, thickness: 10 μm) was preliminarily degreased with an organic solvent, and then degreased by being immersed in an acidic solvent with its one side masked. Thus, the surface of the nickel foil was activated. To 1.0 mol/L of methanesulfonic acid, methanesulfonic acid bismuth as a soluble bismuth salt was added so that Bi³⁺ ions reached 0.18 mol/L. Thus, a plating bath was produced. The nickel foil activated was connected to a power source for current application, and then immersed in the plating bath. Subsequently, the unmasked surface of the nickel foil was electroplated with Bi by controlling the current density to 2 A/dm² so that the thickness reached about 3 μm. The nickel foil subjected to the electroplating was taken out from the acidic bath, and the mask was removed. Then, the nickel foil was cleaned with pure water and dried. Subsequently, in an electric furnace set to an argon atmosphere, the Bi-electroplated nickel foil was heat-treated at 400 C° for 60 hours. The nickel foil heat-treated was subjected to an X-ray diffraction measurement with an X-ray diffractometer (MiniFlex manufactured by Rigaku Corporation) by the 0-20 method using Cu-Kα rays having wavelengths of 1.5405 Å and 1.5444 Å as the X-rays. The X-ray diffraction pattern thus obtained demonstrates that, on the nickel foil, NiBi having a crystal structure that can belong to the monoclinic C2/m space group was generated. FIG. 3 is a graph showing the X-ray diffraction pattern of NiBi produced on the nickel foil in Example 1. Subsequently, the nickel foil was punched to have a size of φ0.92 cm. Thus, on the current collector formed of the nickel foil, a negative electrode was obtained that was a plating layer consisting of NiBi.

### [Production of Battery]

A battery of Example 1 was produced by the following procedure.

First, 80 mg of Li₃YBr₂Cl₄ was put into an insulating outer cylinder and pressure-molded at a pressure of 2 MPa. An amount of 12.0 mg of the positive electrode material was added thereto, and this was pressure-molded at a pressure of 2 MPa. Thus, a stack composed of a positive electrode and a solid electrolyte layer was obtained.

Next, on one side of the solid electrolyte layer opposite to the other side in contact with the positive electrode, the negative electrode was stacked so that the Bi-plated surface was in contact with the solid electrolyte layer. This was pressure-molded at a pressure of 720 MPa to produce a stack composed of the positive electrode, the solid electrolyte layer, and a negative electrode.

Next, stainless steel current collectors were placed on the top and the bottom of the stack, and current collector leads were attached to the current collectors.

Finally, an insulating ferrule was used to block the inside of the insulating outer cylinder from the outside air atmosphere and hermetically seal the insulating outer cylinder. Thus, a battery was produced.

Thus, the battery of Example 1 described above was produced.

### [Charge Test]

A charge test was performed on the battery of Example 1 described above under the following conditions.

The battery was placed in a thermostatic chamber set at 25° C.

Constant-current charge was performed at a current value of 86 μA equivalent to 0.05 C rate (20-hour rate) relative to the theoretical capacity of the battery. The end-of-charge voltage was set to 3.9 V. Next, constant-current discharge was performed. The end-of-discharge voltage was set to 0.5 V.

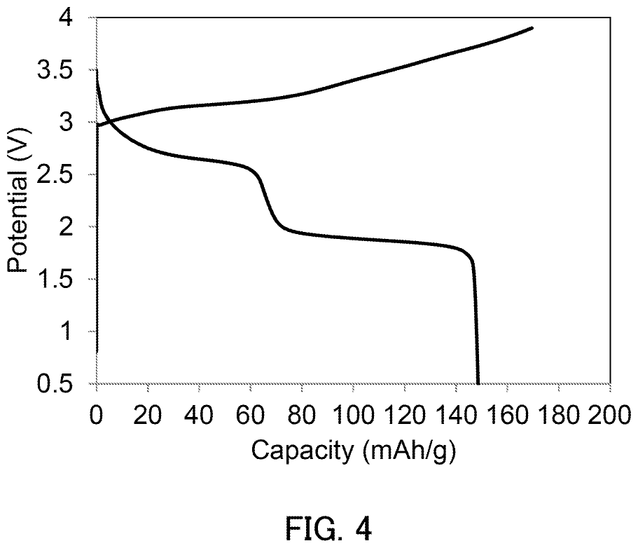

FIG. 4 is a graph showing the charge and discharge curves of the battery of Example 1. The battery of Example 1 was charged and discharged as shown in FIG. 4.

### INDUSTRIAL APPLICABILITY

The battery of the present disclosure can be used as, for example, an all-solid-state lithium-ion secondary battery.

What is claimed is:

1. A battery comprising:
a positive electrode;
a negative electrode; and
an electrolyte layer positioned between the positive electrode and the negative electrode, wherein
the positive electrode includes a positive electrode material,
the positive electrode material includes a positive electrode active material and a first solid electrolyte material,
the positive electrode active material includes a material represented by the following composition formula (1)
LiₓMn_{y}O₂ Formula (1),
the composition formula (1) satisfies 0≤x≤1.05 and 0.9≤y≤1.1, and
the negative electrode includes an alloy as a negative electrode active material, the alloy including Ni and Bi.

2. The battery according to claim 1, wherein
the composition formula (1) satisfies 0≤x≤1.

3. The battery according to claim 2, wherein
the composition formula (1) satisfies x=1.

4. The battery according to claim 1, wherein
the composition formula (1) satisfies y=1.

5. The battery according to claim 1, wherein
the negative electrode includes, as a main component of the negative electrode active material, the alloy including Ni and Bi.

6. The battery according to claim 1, wherein
the alloy including Ni and Bi is represented by the following composition formula (2)
NiBiₐ Formula (2), and
the composition formula (2) satisfies 0<a≤3.

7. The battery according to claim 6, wherein
the composition formula (2) satisfies a=1.

8. The battery according to claim 1, wherein
the negative electrode includes a material represented by the following composition formula (3)
Li_{z}Bi Formula (3), and
the composition formula (3) satisfies 0<z≤3.

9. The battery according to claim 8, wherein
the composition formula (1) satisfies x=0 and y=1, and
the composition formula (3) satisfies z=3.

10. The battery according to claim 1, further comprising a negative electrode current collector electrically connected to the negative electrode, wherein
the negative electrode current collector includes Ni.

11. The battery according to claim 1, wherein
the negative electrode is a plating layer.

12. The battery according to claim 1, wherein
the first solid electrolyte material includes:
Li;
at least one selected from the group consisting of metalloid elements and metal elements except Li; and
at least one selected from the group consisting of Cl and Br.

13. The battery according to claim 1, wherein
the first solid electrolyte material includes a material represented by the following composition formula (4)
Li_{α4}M_{β4}X_{γ4} Formula (4)
where α4, β4, and γ4 are each a value greater than 0,
M is at least one selected from the group consisting of metalloid elements and metal elements except Li, and
X is at least one selected from the group consisting of Cl and Br.

14. The battery according to claim 13, wherein
the composition formula (4) satisfies:
2.5≤α4≤3;
1≤β4≤1.1; and
γ4=6.

15. The battery according to claim 1, wherein
the electrolyte layer includes a first electrolyte layer and a second electrolyte layer,
the first electrolyte layer is positioned between the positive electrode and the negative electrode, and
the second electrolyte layer is positioned between the first electrolyte layer and the negative electrode.
